(19) United States
(12) Patent Application Publication
(10) Pub. No.: US 2025/0245830 A1
(43) Pub. Date: Jul. 31, 2025

(54) IMAGE PROCESSING DEVICE, IMAGE PROCESSING METHOD, AND IMAGE PROCESSING PROGRAM

(71) Applicant: FUJIFILM CORPORATION, Tokyo (JP)

(72) Inventor: Takuya FUCHIGAMI, Tokyo (JP)

(21) Appl. No.: 19/023,399

(22) Filed: Jan. 16, 2025

(30) Foreign Application Priority Data
Jan. 30, 2024 (JP) 2024-011914

(51) Int. Cl. G06T 7/00; G06T 7/73

(52) U.S. Cl. CPC G06T 7/0014; G06T 7/74; G06T 2207/10088; G06T 2207/20081; G06T 2207/20084; G06T 2207/30012

(57) ABSTRACT

A processor performs first processing of acquiring an offset from a reference point of a structure included in an image to a candidate point of a target point related to the reference point, and repeatedly performs second processing of acquiring a new offset to a new candidate point of the target point in which the candidate point of the target point derived based on the offset is used as a new reference point, N times (N≥1) until a predetermined condition is satisfied, to derive the target point.

### CROSS REFERENCE TO RELATED APPLICATIONS

The present application claims priority from Japanese Patent Application No. 2024-011914, filed on Jan. 30, 2024, the entire disclosure of which is incorporated herein by reference.

### BACKGROUND

### Technical Field

The present disclosure relates to an image processing device, an image processing method, and an image processing program.

### Related Art

Various methods for detecting a point representing a pre-defined characteristic structure, that is, a landmark from an image have been proposed (see, for example, JP2022-532039A). In addition, there is also a case in which the landmark is detected by using a learning model trained by deep learning. In the landmark detection using the deep learning, methods, such as heat map regression, coordinate point regression, and offset regression, are often used. In the heat map regression, the deep learning is performed such that a detection result is obtained in which the certainty of being the landmark is given as a ground truth and the certainty of being the landmark on the image is represented by a change in color or the like. In the coordinate point regression, the deep learning is performed such that a coordinate point representing the landmark in the image is given as a ground truth, and the position of the landmark is detected. In the offset regression, the deep learning is performed such that a vector (offset) from each pixel included in the image toward the landmark is given as a ground truth, and an offset from each pixel included in the image toward the landmark is detected.

Meanwhile, a method of detecting the landmark by using both the heat map regression and the offset regression has been proposed. For example, in VERTEBRA-FOCUSED LANDMARK DETECTION FOR SCOLIOSIS ASSESSMENT, Yi et al., 9 Jan. 2020, a method has been proposed in which, in a case of detecting a center of a vertebral body in the vertebrae constituting a spine and four corners of the vertebral body as landmarks, a center of the vertebral body is derived by heat map regression, and the four corners of the vertebral body are derived by offset regression from the center of the vertebral body.

However, in the method described in VERTEBRA-FOCUSED LANDMARK DETECTION FOR SCOLIOSIS ASSESSMENT, Yi et al., 9 Jan. 2020, for example, in a case in which the vertebral body is included in the image, it may not be possible to accurately derive the landmarks such as the four corners of the vertebral body via the offset regression from the center of the vertebral body.

### SUMMARY OF THE INVENTION

The present disclosure has been made in view of the above-described circumstances, and an object of the present disclosure is to enable more accurate derivation of a landmark of a structure included in an image.

The present disclosure provides an image processing device comprising: a processor, in which the processor performs first processing of acquiring an offset from a reference point of a structure included in an image to a candidate point of a target point related to the reference point, and repeatedly performs second processing of acquiring a new offset to a new candidate point of the target point in which the candidate point of the target point derived based on the offset is used as a new reference point, N times (N≥1) until a predetermined condition is satisfied, to derive the target point.

The present disclosure provides an image processing method executed by a computer, the image processing method comprising: performing first processing of acquiring an offset from a reference point of a structure included in an image to a candidate point of a target point related to the reference point; and repeatedly performing second processing of acquiring a new offset to a new candidate point of the target point in which the candidate point of the target point derived based on the offset is used as a new reference point, N times (N≥1) until a predetermined condition is satisfied, to derive the target point.

The present disclosure provides an image processing program causing a computer to execute: a procedure of performing first processing of acquiring an offset from a reference point of a structure included in an image to a candidate point of a target point related to the reference point; and a procedure of repeatedly performing second processing of acquiring a new offset to a new candidate point of the target point in which the candidate point of the target point derived based on the offset is used as a new reference point, N times (N≥1) until a predetermined condition is satisfied, to derive the target point.

According to the present disclosure, the landmark of the structure included in the image can be accurately derived.

### BRIEF DESCRIPTION OF THE DRAWINGS

FIG. 1 is a perspective view showing an outline of a medical information system to which an image processing device according to an embodiment of the present disclosure is applied.

FIG. 2 is a diagram showing a hardware configuration of the image processing device according to the embodiment of the present disclosure.

FIG. 3 is a diagram showing a functional configuration of the image processing device according to the embodiment of the present disclosure.

FIG. 4 is a diagram showing a reference point.

FIG. 5 is a diagram showing learning of a derivation model.

FIG. 6 is a diagram showing a weight during learning.

FIG. 7 is a diagram showing a derived target point.

FIG. 8 is a diagram showing derivation of a further target point.

FIG. 9 is a diagram showing a result of derivation of the reference point and the target point in a medical image.

FIG. 10 is a diagram showing an imaging surface of an intervertebral disc.

FIG. 11 is a flowchart showing processing performed in the present embodiment.

FIG. 12 is a diagram showing a medical image including a vertebral body with a compression fracture.

FIG. 13 is a diagram showing a Cobb angle.

FIG. 14 is a diagram showing a tomographic image of a breast.

### DETAILED DESCRIPTION

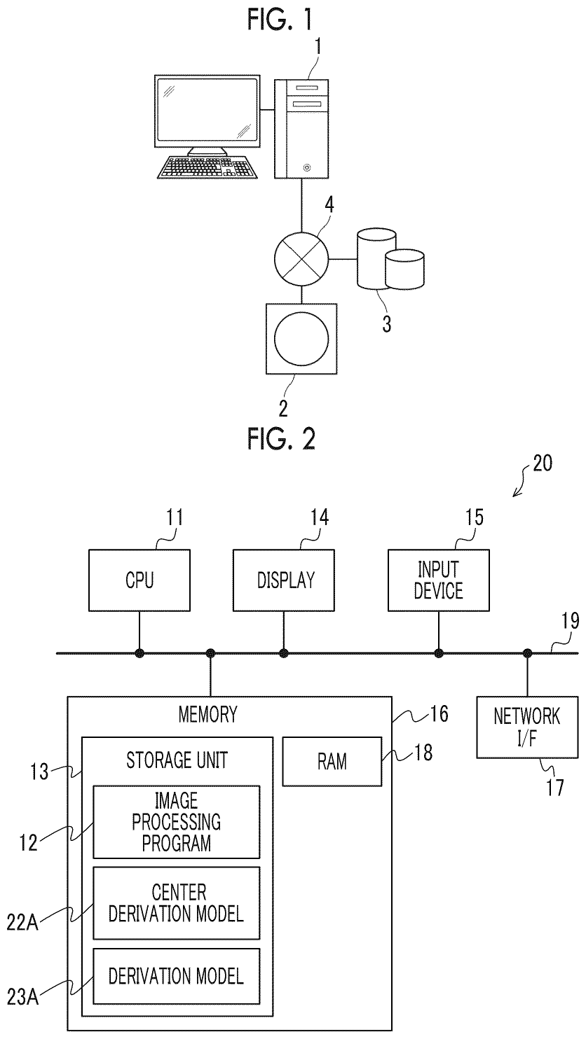

Hereinafter, an embodiment of the present disclosure will be described with reference to the drawings. First, a configuration of a medical information system to which an image processing device according to the present embodiment is applied will be described. FIG. 1 is a diagram showing a schematic configuration of the medical information system. In the medical information system shown in FIG. 1, a computer 1 including the image processing device according to the present embodiment, an imaging apparatus 2, and an image storage server 3 are connected via a network 4 in a communicable state.

The computer 1 includes the image processing device according to the present embodiment, and an image processing program according to the present embodiment is installed in the computer 1. The computer 1 may be a workstation or a personal computer directly operated by a doctor who makes a diagnosis, or may be a server computer connected to the workstation or the personal computer via the network. The image processing program is stored in a storage device of the server computer connected to the network or in a network storage to be accessible from the outside, and is, in response to a request, downloaded and installed in the computer 1 used by the doctor. Alternatively, the image processing program is distributed in a state of being recorded on a recording medium, such as a digital versatile disc (DVD) or a compact disc read-only memory (CD-ROM), and is installed in the computer 1 from the recording medium.

The imaging apparatus 2 is an apparatus that generates a two-dimensional image or a three-dimensional image representing a part of a subject to be diagnosed by imaging the part, and is specifically a radiography apparatus, a computed tomography (CT) apparatus, a magnetic resonance imaging (MRI) apparatus, a positron emission tomography (PET) apparatus, or the like. The image of the subject generated by the imaging apparatus 2 is transmitted to the image storage server 3 and stored in the image storage server 3. It should be noted that the three-dimensional image includes a plurality of tomographic images or an image composed of three-dimensional coordinates generated from the plurality of tomographic images.

The image storage server 3 is a computer that stores and manages various types of data, and comprises a large-capacity external storage device and software for database management. The image storage server 3 communicates with another device via the wired or wireless network 4, and transmits and receives image data and the like to and from the other device. Specifically, the image storage server 3 acquires various types of data including the image data of the image generated by the imaging apparatus 2 via the network, and stores and manages the various types of data in the recording medium, such as the large-capacity external storage device. It should be noted that a storage format of the image data and the communication between the devices via the network 4 are based on a protocol such as digital imaging and communication in medicine (DICOM).

Hereinafter, the image processing device according to the present embodiment will be described. FIG. 2 is a diagram showing a hardware configuration of the image processing device according to the present embodiment. As shown in FIG. 2, the image processing device 20 includes a central processing unit (CPU) 11, a display 14, an input device 15, a memory 16, and a network interface (I/F) 17 connected to the network 4. The CPU 11, the display 14, the input device 15, the memory 16, and the network I/F 17 are connected to a bus 19. It should be noted that the CPU 11 is an example of a processor in the present disclosure.

The memory 16 includes the storage unit 13 and a random access memory (RAM) 18. The RAM 18 is a primary storage memory, and is, for example, a RAM such as a static random access memory (SRAM) or a dynamic random access memory (DRAM).

The storage unit 13 is a non-volatile memory and is implemented by, for example, at least one of a hard disk drive (HDD), a solid state drive (SSD), an electrically erasable and programmable read only memory (EEPROM), or a flash memory. An image processing program 12 according to the present embodiment is stored in the storage unit 13 as a storage medium. The CPU 11 reads out the image processing program 12 from the storage unit 13, loads the readout image processing program 12 in the RAM 18, and executes the loaded image processing program 12. It should be noted that the storage unit 13 also stores a center derivation model 22A and a derivation model 23A, which will be described later.

The display 14 is a device that displays various screens, and is, for example, a liquid crystal display or an electro luminescence (EL) display. The input device 15 is a device for a user to perform input, and is, for example, at least any one of a keyboard, a mouse, a microphone for audio input, a touchpad for proximity input including contact, or a camera for gesture input. The network I/F 17 is an interface for connection to the network 4.

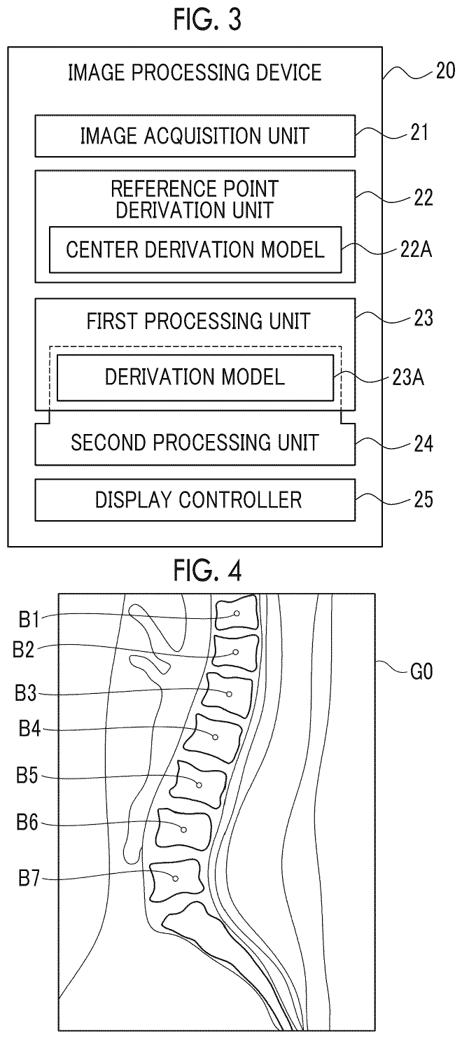

Hereinafter, a functional configuration of the image processing device according to the present embodiment will be described. FIG. 3 is a diagram showing the functional configuration of the image processing device according to the present embodiment. As shown in FIG. 3, the image processing device 20 comprises an image acquisition unit 21, a reference point derivation unit 22, a first processing unit 23, a second processing unit 24, and a display controller 25. Then, in a case in which the CPU 11 executes the image processing program 12, the CPU 11 functions as the image acquisition unit 21, the reference point derivation unit 22, the first processing unit 23, the second processing unit 24, and the display controller 25.

The image acquisition unit 21 acquires a medical image G0 that is a processing target from the image storage server 3 in response to an instruction issued from an operator by using the input device 15. In the present embodiment, the medical image G0 is an MRI image of a sagittal cross section including a spinal column of a human body. The MRI image may be a three-dimensional image or a two-dimensional image. It should be noted that the spinal column is composed of a plurality of vertebrae. The vertebra is composed of a vertebral body, a spinal process, and the like.

The reference point derivation unit 22 analyzes the medical image G0 to derive the center of each of a plurality of vertebral bodies included in the medical image G0 as a reference point. It should be noted that, for example, a centroid of the vertebral body can be used as the center of the vertebral body. Therefore, the reference point derivation unit 22 uses the center derivation model 22A that has been trained to derive the center of the vertebral body. It should be noted that the center derivation model 22A is stored in the storage unit 13. The vertebral body is an example of a structure in the present disclosure.

The center derivation model 22A is constructed by training a neural network through deep learning using image data representing an image of the vertebral body of which the center is specified, so as to specify the center of the vertebral body in a case in which an image including the vertebral body is input. The deep learning may use coordinate point regression in which a coordinate position of the center position of the vertebral body is used as ground truth data, to perform learning such that the coordinate position of the center of the vertebral body is output in response to the input of image data. In addition, heat map regression may be used in which the certainty of being the center position of the vertebral body is used as the ground truth data, to perform learning such that the certainty of the position at which the center of the vertebral body exists is output as a heat map in response to the input of the image data. In addition, offset regression may be used in which a vector (offset) from each pixel included in the image to the center of the vertebral body is used as the ground truth data, to perform learning such that the offset from each pixel of the image represented by the image data to the center of the vertebral body is output in response to the input of the image data.

As a result, as shown in FIG. 4, the center of the vertebral body is derived as reference points B1 to B7 for each of the plurality of (here, seven) vertebral bodies included in the medical image G0. It should be noted that, in FIG. 4, an image of one sagittal cross section included in the medical image G0 is shown.

The first processing unit 23 performs first processing of acquiring the offset from each of the reference points B1 to B7 derived by the reference point derivation unit 22 to a candidate point of a target point related to each of the reference points B1 to B7. In the present embodiment, both the reference point and the target point are located in the vertebral body. The reference point is the center of the vertebral body as described above, and the target point is a point on a boundary of a corner part of the vertebral body. In the present embodiment, the target point related to the reference point means the target point in the same vertebral body as the reference point. The target point is not limited to the point located on the boundary of the corner part. For example, the point may be a point located near the boundary at a position in the vertebral body separated from the point located on the boundary of the corner part of the vertebral body by several pixels. It should be noted that, since the medical image G0 is a three-dimensional image, and the vertebral body is generally a rectangular parallelepiped, there are eight corner parts of the vertebral body.

In order to acquire the offset, the first processing unit 23 uses the derivation model 23A that has been trained to derive the offset to the target point. The derivation model 23A is also stored in the storage unit 13.

The derivation model 23A is constructed by training the neural network through the deep learning so as to output the target point in a case in which the image of the vertebral body in which the reference point is specified is input. The deep learning is learning in which the vector (offset) from each pixel included in the image to the target point, which is the corner part of the vertebral body, is used as the ground truth data, and the neural network outputs the vector from each pixel of the image represented by the image data to the target point, that is, the offset, in response to the input of the image data. It is considered that the number of output channels of the neural network is prepared, for example, by the product of the number of dimensions and the number of target points. For example, in a case in which the image data is a three-dimensional image, there are eight corner parts of the vertebral body, so that the number of output channels is 3×8=24. In a case in which the image data is a two-dimensional image, there are four corner parts of the vertebral body, so that the number of output channels is 2×4=8.

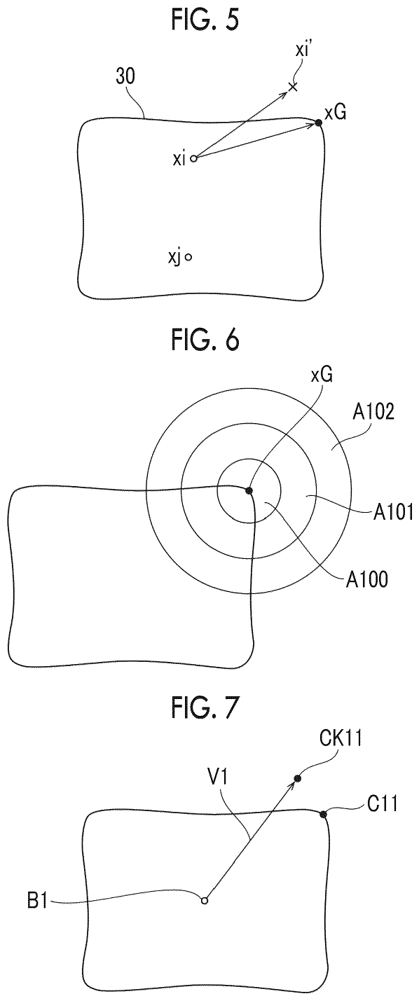

FIG. 5 is a diagram showing learning of the derivation model 23A. It should be noted that the medical image G0 is a three-dimensional image, but the description will be made with a two-dimensional image in FIG. 5. In addition, FIG. 5 shows the learning of the offset in which a point (vertex) xG in an upper right corner part of the vertebral body 30 is set as the target point. During the learning, the target point predicted based on the offset in a certain pixel in the image does not match a target point xG as the ground truth. Therefore, the target point predicted from a certain pixel xi derived during the learning is denoted by xi′. It should be noted that the coordinates of the pixel xi, the target point xG, and the predicted target point xi′ are three-dimensional in a case of the three-dimensional image and are two-dimensional in a case of the two-dimensional image. In addition, a pixel xj shown in FIG. 5 is a pixel that is farther from the target point xG than the pixel xi.

In this case, an offset loss Ltotal is derived by the following Expressions (1) to (3). Here, pred_offseti is an offset predicted from the pixel xi to the predicted target point xi′, gt_offseti is an offset (ground truth offset) of the ground truth data from the pixel xi to the vertex xG shown in FIG. 5, and wi and wj are weights in a case of deriving a loss Loffset for the points xi and xj, respectively. In Expressions (2) to (4), an L1 norm or the like may be used instead of the L2 norm.

$${L}_{total} = ( 1 - λ ) {L}_{offset} + λ {L}_{dst} \qquad ( 1 )$$

$${L}_{offset} = {\sum }_{i} {w}_{i} ‖ {pred\_offset}_{i} - {gt\_offset}_{i} ‖ \qquad ( 2 )$$

$${L}_{dst} = {\sum }_{i} ‖ {x}_{G} - {x}_{i}^{′} ‖ \qquad ( 3 )$$

Here, λ∈[0,1], |·| is 12 norm.

In a case of the learning of the derivation model 23A, a deviation occurs between the target point predicted from each pixel using the offset derived during the learning and the target point given as the ground truth. Therefore, in the learning of the derivation model 23A, the deviation derived in this way may be used as a loss. This loss is a loss Ldst shown in Expression (3). As a result, it is possible to further improve the accuracy in a case of the derivation of the target point.

It should be noted that only Loffset may be used as the loss in a case of the learning of the derivation model 23A. In this case, Ltotal=Loffset.

In the present embodiment, the derivation model 23A is constructed by repeatedly performing the learning until a predetermined condition is satisfied. The predetermined condition may be a condition in which the loss Ltotal is equal to or less than a predetermined threshold value or that the learning is completed a predetermined number of times, but the present disclosure is not limited to this.

It should be noted that, in the learning, the weighting in a case of the derivation of the loss may be increased as the pixel is closer to the target point. For example, regarding the target point xG, as shown in FIG. 6, it is preferable to set concentric circular regions A100, A101, and A102 with the target point xG as the center and to increase the weighting in a case of the derivation of the loss in an order of the region A102, the region A101, and the region A100. In this case, the weights wi and wj are set as shown in Expression (4). As described above, by performing the offset regression by increasing the weighting of the loss for the pixel close to the target point, it is possible to further improve the accuracy in the derivation of the offset to the target point for the pixel close to the target point.

$${w}_{i} > {w}_{j} if ‖ {x}_{G} - {x}_{i} ‖ < ‖ {x}_{G} - {x}_{j} ‖ \qquad ( 4 )$$

It should be noted that, in a case of the learning of the derivation model 23A, the loss may be obtained only in a predetermined range around the reference point and the target point, instead of the entire image used for the learning. In other words, the loss may not be obtained outside the predetermined range around each of the reference point and the target point. For example, the loss in a range of the region A102 of the target point shown in FIG. 6 may not be obtained. In addition, similarly, for the reference point, the loss need not be obtained in a region having a range equal to or larger than a certain range with the reference point as a reference. As a result, an amount of operation in the learning can be reduced.

The first processing unit 23 derives an offset V1 from the reference point to the target point related to the reference point by using the derivation model 23A. On the other hand, in the vertebral body, there is a relatively long distance between the center and the corner part. Therefore, in a case in which the offset V1 from the reference point to the target point is derived, as shown in FIG. 7, a situation may occur in which a target point derived based on the offset V1 does not match an actual target point C11 (that is, a point at the corner part of the vertebral body). Therefore, in the present embodiment, the target point derived based on the offset V1 will be referred to as a candidate point CK11 of the target point.

In the present embodiment, the second processing unit 24 performs second processing of acquiring a new offset V2 to the target point C11 by using the candidate point CK11 of the target point derived based on the offset V1 as a new reference point by using the derivation model 23A.

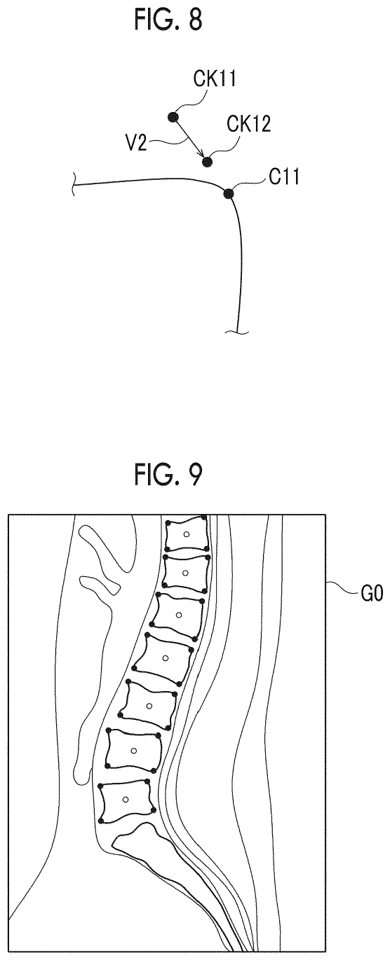

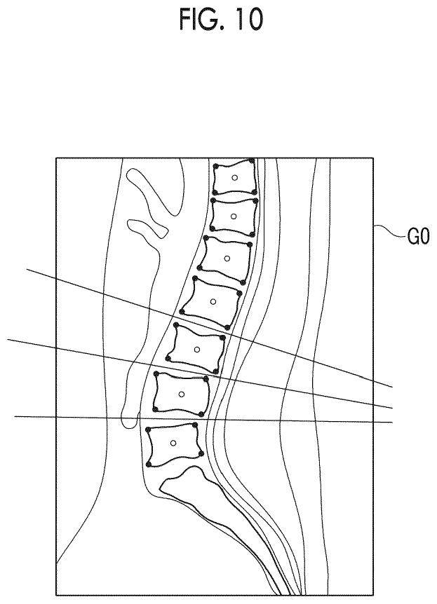

Here, the candidate point CK11 of the target point derived based on the offset V1 is located at a position closer to the target point C11 than the reference point B1. Therefore, in a case in which the new offset V2 to the target point is derived by using the candidate point CK11 as the new reference point, the candidate point CK12 of the target point derived based on the new offset V2 is closer to the target point C11 or matches the target point as shown in FIG. 8.

In the present embodiment, the second processing unit 24 repeatedly performs the second processing N times (N≥1) until a predetermined condition is satisfied. That is, since the offset is the vector, the second processing unit 24 repeatedly performs the second processing until an absolute value of the offset from the candidate point CK12 of the target point to the target point C11 derived based on the new offset V2 is less than a predetermined threshold value Th1. It should be noted that, in a case in which the absolute value of the offset from the candidate point CK12 to the target point C11 is less than the threshold value Th1, the second processing unit 24 ends the processing with only one second processing.

On the other hand, there is a case in which the offset from the candidate point CK12 to the target point C11 of the target point derived based on the new offset V2 is equal to or greater than the predetermined threshold value Th1. In this case, the second processing unit 24 repeatedly performs the second processing, in which the candidate point CK12 of the target point derived based on the new offset V2 is used as the reference point, until the offset from the candidate point CK12 of the target point derived based on the new offset V2 to the target point is less than the threshold value Th1. As a result, the second processing unit 24 can derive the corner part of the vertebral body as the target point. FIG. 9 is a diagram showing derivation results of the reference point and the target point in the medical image G0. It should be noted that, in FIG. 9, the reference point is shown by a white circle, and the target point is shown by a black circle. Since the image shown in FIG. 9 is a two-dimensional image, the number of target points is four.

The reference point and the target point derived in this manner are used in the following processing. For example, the reference point is used for detection of a center line of a spine and the like. For example, in a case in which the medical image G0 is a scout image used for positioning during the imaging using the CT apparatus or the imaging using the MRI apparatus, a line (in a case of a three-dimensional image, a plane) is drawn between the target points facing each other in adjacent vertebral bodies as shown in FIG. 10, and the target point is used for the derivation of the imaging surface for imaging the intervertebral disc during the imaging.

It should be noted that the condition for the second processing unit 24 to repeatedly perform the second processing is not limited to the condition in which the absolute value of the offset from the candidate point CK12 of the target point to the target point derived based on the new offset V2 is less than the threshold value Th1. The condition may be a condition in which N reaches a predetermined number of times.

In addition, in a case in which the second processing unit 24 performs the second processing, the learning is difficult in a case in which the target point to be derived is located at a position away from the reference point. Therefore, in a case in which the second processing unit 24 performs the second processing, the threshold value Th1 may be increased as a distance to the target point to be derived from the reference point is increased. That is, different threshold values Th1 may be set for a plurality of anatomical structures. The threshold value may be a value derived based on a distance between a reference value and a target value associated with the anatomical structure. Specifically, it is supposed that there are a distance L31 between a reference point B31 and a derived target point CK31 for a certain vertebra and a distance L32 between a reference point B32 and a derived target point CK32 for another vertebra. In a case in which the distance L31 is relatively shorter than the distance L32, the threshold value Th1 used in a case of the derivation of the target point CK31 need only be made relatively smaller than a threshold value Th2 used in a case of the derivation of the target point CK32.

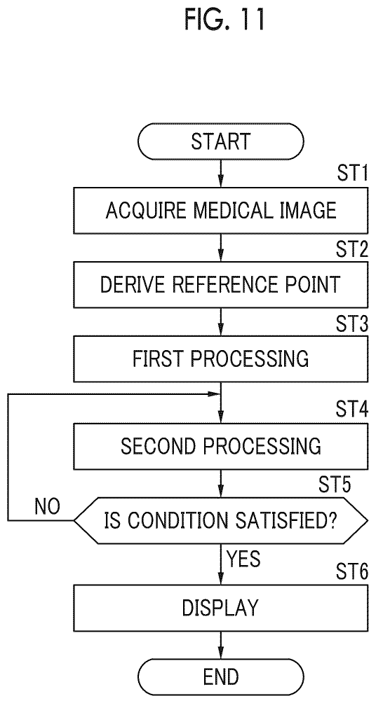

Hereinafter, the processing performed in the present embodiment will be described. FIG. 11 is a flowchart showing the processing performed in the present embodiment. First, the image acquisition unit 21 acquires the medical image G0 for the derivation of the reference point and the target point from the image storage server 3 (step ST1).

Next, the reference point derivation unit 22 derives the reference point from the medical image G0 (step ST2). That is, the center of each of the plurality of vertebral bodies included in the medical image G0 is derived as the reference point. Then, the first processing unit 23 performs the first processing of acquiring the offset from the reference point to the target point related to the reference point by using the derivation model 23A (step ST3).

Next, the second processing unit 24 performs the second processing of acquiring the new offset to the target point in which the candidate point of the target point derived based on the offset is used as the new reference point by using the derivation model 23A (step ST4).

Next, the second processing unit 24 determines whether or not a predetermined condition is satisfied (step ST5). In a case in which a NO determination is made in step ST5, the second processing unit 24 returns to step ST4 and repeatedly performs the processing of steps ST4 and ST5. In a case in which a YES determination is made in step ST5, the medical image G0 in which the derived reference point and target point are drawn is displayed on the display 14 (step ST6), and the processing ends. It should be noted that, instead of the display, the processing using the reference point and the target point may be performed as described above.

As described above, in the present embodiment, the first processing of acquiring the offset from the reference point to the target point and the second processing of acquiring the new offset to the target point, in which the candidate point of the target point derived based on the offset is used as the new reference point, are repeatedly performed N times (N≥1) until the predetermined condition is satisfied. By repeatedly performing the second processing in this way, the new reference point approaches the target point, and thus the accuracy of the derivation of the target point is improved by repetition. Therefore, as described in VERTEBRA-FOCUSED LANDMARK DETECTION FOR SCOLIOSIS ASSESSMENT, Yi et al., 9 Jan. 2020, the target point can be derived with higher accuracy than the target point derived only by using the offset acquired by the first processing.

In particular, it is difficult to detect the point at the corner part of the vertebral body because the feature is ambiguous compared to the center of the vertebral body. In addition, the point at the corner part of the vertebral body is located at a position away from the center of the vertebral body, which is the reference point. According to the present embodiment, since the second processing is repeatedly performed, it is possible to accurately detect the target point of which the feature is relatively ambiguous compared to the reference point or that is located at a position away from the reference point.

In addition, the vertebral body may be deformed, for example, in a case in which a shape of a vertebral body 31 is deformed due to a disease such as a compression fracture, as shown in FIG. 12. As described above, even in a case in which the shape of the vertebral body is deformed from a healthy state, the second processing is repeatedly performed in the present embodiment, and thus the corner part of the deformed vertebral body can be accurately derived as the target point.

In addition, as described in the document by Aubert et al. (Automatic spine and pelvis detection in frontal X-rays using deep neural networks for patch displacement learning, Benjamin Aubert et al., 2016 IEEE 13th International Symposium on Biomedical Imaging (ISBI), 13 Apr. 2016), a method of detecting a landmark by repeatedly performing processing of setting a patch in an image, deriving an offset from the set patch, and moving the patch based on the derived offset has been proposed. In the present embodiment, the offset for all the pixels is derived by the processing of one inference instead of deriving the offset each time the patch is moved. Therefore, the number of times of performing the inference processing is smaller than that of the method described in the document by Aubert et al., and as a result, the amount of operation is reduced, and thus the position of the target point can be derived at high speed.

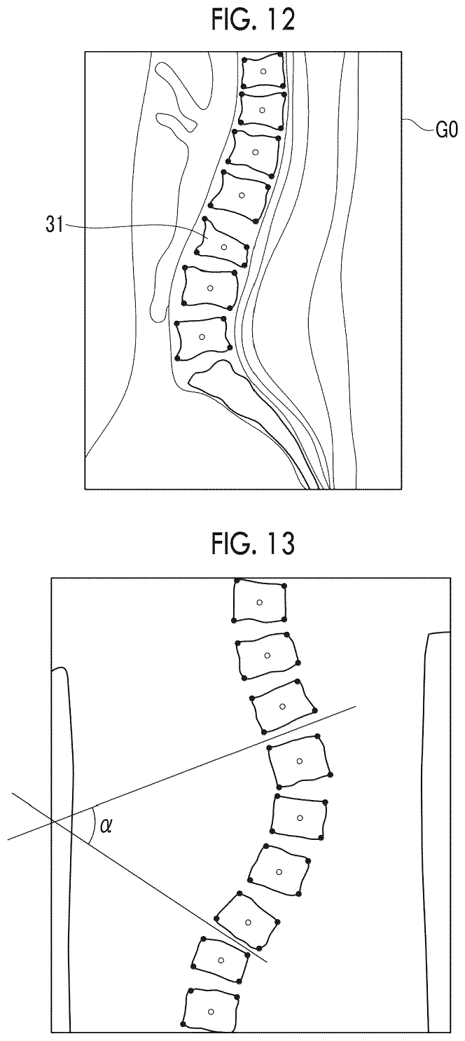

It should be noted that, in the above-described embodiment, the MRI image of the sagittal cross section including the spinal column is used as the medical image G0, but the present disclosure is not limited to this. An MRI image of a coronal cross section including the spinal column may be used as the medical image G0. In this case, as shown in FIG. 13, the reference point and the target point are acquired in each of the vertebral bodies constituting the spinal column as seen from the front of the subject in the coronal cross section. It should be noted that FIG. 13 shows a coronal image of a patient with scoliosis. The reference points derived in the coronal cross section are used for the detection of the center line of the spine and the like. The target point is used to derive a Cobb angle used for the diagnosis of the scoliosis.

In this case, as shown in FIG. 13, a line is drawn between the target points facing each other in the adjacent vertebral bodies, and an angle α formed by an intersection of the lines can be derived as the Cobb angle. In addition, in a case in which the medical image G0 of the coronal cross section is a scout image used for positioning during the imaging using the CT apparatus or the imaging using the MRI apparatus, the medical image G0 can be used to draw the line between the target points facing each other in the adjacent vertebral bodies and to derive the imaging surface for imaging the intervertebral disc during the imaging.

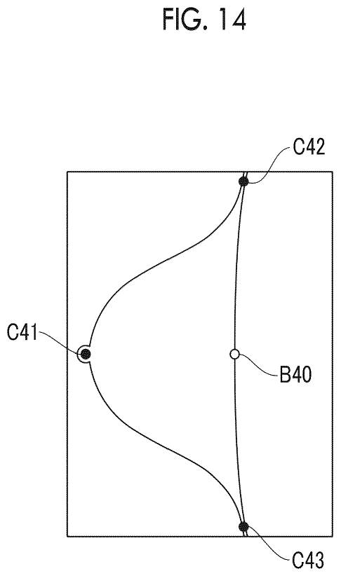

In addition, in the above-described embodiment, the medical image G0 including the spinal column is the processing target, but the present disclosure is not limited to this. The medical image G0 including an anatomical structure, such as a breast, a brain, or a heart, can be used as the processing target. For example, in a case in which the medical image G0 is a tomographic image representing one tomographic plane of an MRI image of the breast, as shown in FIG. 14, the center of the breast need only be derived as a reference point B40, and a nipple, an upper end, and a lower end of the breast may be derived as target points C41, C42, and C43, respectively. In addition, in a case in which the medical image G0 is a CT image of the brain, the center of the brain may be derived as the reference point, and the center of the orbit may be derived as the target point for deriving an orbitomeatal line (OM line). In addition, in a case in which the medical image is an MRI image or a CT image of the heart, the center of the heart may be derived as the reference point, and a connection point between the heart and a large blood vessel, such as the aorta and the superior vena cava, may be derived as the target point.

Further, in the above-described embodiment, the center derivation model 22A derives the reference point, and the derivation model 23A derives the offset, but the present disclosure is not limited to this. Only one derivation model that derives the reference point and derives the offset may be used. In this case, the derivation model performs common processing of the derivation of the reference point and the derivation of the offset in the previous stage, and branches and performs processing in accordance with the task of the derivation of the reference point and the task of the derivation of the offset in the subsequent stage.

In addition, in the above-described embodiment, the image processing device according to the present embodiment comprises the reference point derivation unit 22, but the present invention is not limited to this. In a case in which the medical image G0 in which the reference points are derived in advance is stored in the image storage server 3, it is possible to configure the image processing device according to the present embodiment without providing the reference point derivation unit 22.

In addition, in the above-described embodiment, the medical image is used to handle the image processing, but the present disclosure is not limited to this. The technology of the present disclosure can also be applied to a case in which the reference point and the target point are derived for a general photographic image other than the medical image.

In the above-described embodiment, for example, the following various processors can be used as a hardware structure of processing units that execute various types of processing, such as the image acquisition unit 21, the reference point derivation unit 22, the first processing unit 23, the second processing unit 24, and the display controller 25. As described above, the various processors include, in addition to the CPU that is a general-purpose processor which executes software (program) and functions as various processing units, a graphics processing unit (GPU), a programmable logic device (PLD) that is a processor whose circuit configuration can be changed after manufacture, such as a field programmable gate array (FPGA), and a dedicated electrical circuit that is a processor having a circuit configuration which is designed for exclusive use in order to execute specific processing, such as an application specific integrated circuit (ASIC).

One processing unit may be configured by one of these various processors, or may be configured by combining two or more processors of the same type or different types (for example, by combining a plurality of FPGAs or combining of the CPU and the FPGA). A plurality of the processing units may be configured by one processor.

As an example of configuring the plurality of processing units by one processor, first, as represented by a computer of a client, a server, and the like there is a form in which one processor is configured by combining one or more CPUs and software and this processor functions as the plurality of processing units. Second, as represented by a system on a chip (SoC) or the like, there is a form of using a processor that implements the function of the entire system including the plurality of processing units by one integrated circuit (IC) chip. In this way, as the hardware structure, the various processing units are configured by using one or more of the various processors described above.

Further, as the hardware structures of these various processors, more specifically, an electrical circuit (circuitry) in which circuit elements such as semiconductor elements are combined can be used.

Hereinafter, supplementary notes of the present disclosure will be described.

### Supplementary Note 1

An image processing device comprising: a processor, in which the processor performs first processing of acquiring an offset from a reference point of a structure included in an image to a candidate point of a target point related to the reference point, and repeatedly performs second processing of acquiring a new offset to a new candidate point of the target point in which the candidate point of the target point derived based on the offset is used as a new reference point, N times (N≥1) until a predetermined condition is satisfied, to derive the target point.

### Supplementary Note 2

The image processing device according to supplementary note 1, in which the processor analyzes the image to derive the reference point.

### Supplementary Note 3

The image processing device according to supplementary note 2, in which the processor uses a derivation model that has been trained through learning to derive the reference point from the image, to derive the reference point.

### Supplementary Note 4

The image processing device according to supplementary note 3, in which the learning is learning via heat map regression, coordinate point regression, or offset regression.

### Supplementary Note 5

The image processing device according to any one of supplementary notes 1 to 4, in which the predetermined condition is a condition in which the N reaches a predetermined number of times or an absolute value of the new offset is less than a predetermined threshold value.

### Supplementary Note 6

The image processing device according to any one of supplementary notes 1 to 5, in which the reference point and the target point related to the reference point are located in the same structure.

### Supplementary Note 7

The image processing device according to supplementary note 6, in which the target point has a feature that is relatively ambiguous as compared to the reference point.

### Supplementary Note 8

The image processing device according to supplementary note 6 or 7, in which the reference point is located inside the structure, and the target point is located on a boundary of the structure.

### Supplementary Note 9

The image processing device according to any one of supplementary notes 1 to 8, in which the processor performs the first processing and the second processing by using a derivation model that has been trained through learning via offset regression.

### Supplementary Note 10

The image processing device according to supplementary note 9, in which the learning is learning in which a weight for an offset loss is larger as a position is closer to the target point.

### Supplementary Note 11

The image processing device according to supplementary note 9 or 10, in which the learning is learning in which an offset loss is derived only in a predetermined range around the reference point and a predetermined range around the target point.

### Supplementary Note 12

The image processing device according to any one of supplementary notes 9 to 11, in which the learning is learning in which a deviation between a position of the candidate point of the target point repeatedly derived during the learning and a ground truth position of the target point is used as a further loss.

### Supplementary Note 13

An image processing method executed by a computer, the image processing method comprising: performing first processing of acquiring an offset from a reference point of a structure included in an image to a candidate point of a target point related to the reference point; and repeatedly performing second processing of acquiring a new offset to a new candidate point of the target point in which the candidate point of the target point derived based on the offset is used as a new reference point, N times (N≥1) until a predetermined condition is satisfied, to derive the target point.

### Supplementary Note 14

An image processing program causing a computer to execute: a procedure of performing first processing of acquiring an offset from a reference point of a structure included in an image to a candidate point of a target point related to the reference point; and a procedure of repeatedly performing second processing of acquiring a new offset to a new candidate point of the target point in which the candidate point of the target point derived based on the offset is used as a new reference point, N times (N≥1) until a predetermined condition is satisfied, to derive the target point.

What is claimed is:

1. An image processing device comprising:
a processor,
wherein the processor
performs first processing of acquiring an offset from a reference point of a structure included in an image to a candidate point of a target point related to the reference point, and
repeatedly performs second processing of acquiring a new offset to a new candidate point of the target point in which the candidate point of the target point derived based on the offset is used as a new reference point, N times (N≥1) until a predetermined condition is satisfied, to derive the target point.

2. The image processing device according to claim 1,
wherein the processor analyzes the image to derive the reference point.

3. The image processing device according to claim 2,
wherein the processor uses a derivation model that has been trained through learning to derive the reference point from the image, to derive the reference point.

4. The image processing device according to claim 3,
wherein the learning is learning via heat map regression, coordinate point regression, or offset regression.

5. The image processing device according to claim 1,
wherein the predetermined condition is a condition in which the N reaches a predetermined number of times or an absolute value of the new offset is less than a predetermined threshold value.

6. The image processing device according to claim 1,
wherein the reference point and the target point related to the reference point are located in the same structure.

7. The image processing device according to claim 6,
wherein the target point has a feature that is relatively ambiguous as compared to the reference point.

8. The image processing device according to claim 6,
wherein the reference point is located inside the structure, and the target point is located on a boundary of the structure.

9. The image processing device according to claim 1,
wherein the processor performs the first processing and the second processing by using a derivation model that has been trained through learning via offset regression.

10. The image processing device according to claim 9,
wherein the learning is learning in which a weight for an offset loss is larger as a position is closer to the target point.

11. The image processing device according to claim 9,
wherein the learning is learning in which an offset loss is derived only in a predetermined range around the reference point and a predetermined range around the target point.

12. The image processing device according to claim 9,
wherein the learning is learning in which a deviation between a position of the candidate point of the target point repeatedly derived during the learning and a ground truth position of the target point is used as a further loss.

13. An image processing method executed by a computer, the image processing method comprising:
performing first processing of acquiring an offset from a reference point of a structure included in an image to a candidate point of a target point related to the reference point; and
repeatedly performing second processing of acquiring a new offset to a new candidate point of the target point in which the candidate point of the target point derived based on the offset is used as a new reference point, N times (N≥1) until a predetermined condition is satisfied, to derive the target point.

14. A non-transitory computer-readable storage medium that stores an image processing program causing a computer to execute:
a procedure of performing first processing of acquiring an offset from a reference point of a structure included in an image to a candidate point of a target point related to the reference point; and
a procedure of repeatedly performing second processing of acquiring a new offset to a new candidate point of the target point in which the candidate point of the target point derived based on the offset is used as a new reference point, N times (N≥1) until a predetermined condition is satisfied, to derive the target point.
